(19) United States
(12) Patent Application Publication
(10) Pub. No.: US 2009/0200222 A1
(43) Pub. Date: Aug. 13, 2009

(54) System and method for filter containment

(76) Inventors: Mauro G. DelleMonache, Dedham, MA (US); Ralph J. Stankowski, Westford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/319,847

(22) Filed: Jan. 13, 2009

Related U.S. Application Data
(60) Provisional application No. 61/065,071, filed on Feb. 8, 2008.

(51) Int. Cl. B01D 35/30; B65D 51/16

(52) U.S. Cl. 210/233; 220/374; 206/524.6; 220/378; 29/402.08

(57) ABSTRACT

A filter container comprises a top cap, and a bowl formed of a rigid material. The top cap includes a top cap flange that includes a first path around at least a portion of the top cap flange. The bowl includes a bowl flange that includes a second path around at least a portion of the bowl flange. At least one of the first path and the second path include a reduced thickness of material by comparison with surrounding material. The first path is at a different radial distance from a central axis of the filter container than the second path around the extent of both the first path and the second path, such that exerting a force on an opening member creates a tear through the top cap flange and bowl flange, the tear forming between the first path and the second path and allowing opening of the filter container.

### RELATED APPLICATION

This application claims the benefit of U.S. Provisional Application No. 61/065,071, filed on Feb. 8, 2008. The entire teachings of the above application are incorporated herein by reference.

### BACKGROUND OF THE INVENTION

Filters used in applications such as the filtration of semiconductor manufacturing process fluids require careful shipment and handling. Typically, such filters are shipped in a wet state, and are used to filter substances that are hazardous to operators. To change out a filter, an operator uses a sharp object to puncture the package, which risks damaging the filter and introducing contamination into a manufacturing process in which the filter is used. Once the package is opened, the filter may de-wet if not inserted immediately into the manufacturing process. When a fresh filter is being used to replace a spent one that has been in contact with hazardous chemicals, the operator transports the spent filter by hand, or places it on a flat surface, which creates potential health hazards by exposing the operator to fumes or allowing chemicals to leach onto the surface. The spent filter is disposed of in a hazardous materials bag, which has the risk of puncturing and exposing operators to hazardous chemicals.

### SUMMARY OF THE INVENTION

In accordance with an embodiment of the invention, there is provided a filter container. The filter container comprises a top cap, and a bowl formed of a rigid material. The top cap includes a top cap flange that includes a first path around at least a portion of the top cap flange. The bowl includes a bowl flange that includes a second path around at least a portion of the bowl flange. At least one of the first path and the second path includes a reduced thickness of material by comparison with surrounding material. The first path is at a different radial distance from a central axis of the filter container than the second path around the extent of both the first path and the second path, such that exerting a force on an opening member creates a tear through the top cap flange and bowl flange, the tear forming between the first path and the second path and allowing opening of the filter container.

In a further, related embodiment, a top cap mating member forms a third path around at least a portion of the top cap, and a bowl mating member forms a fourth path around at least a portion of the bowl. The top cap is sealed to the bowl such that, before opening of the seal of the top cap to the bowl, the top cap mating member is positioned above the seal of the top cap to the bowl, and the bowl mating member is positioned below the seal of the top cap to the bowl. The third path is capable of mating with the fourth path such that after opening of the seal of the top cap to the bowl, the top cap mating member may be mated with the bowl mating member to close the top cap to the bowl.

In further related embodiments, the first path, the second path, the third path and the fourth path may be substantially circular, the first path having a smaller diameter than the second path, and the third path having a smaller diameter than the fourth path. The top cap may further include an inlet tube and a vent tube. The filter container may further include a filter cartridge within the container, the filter cartridge being immersed in a liquid, which may be deionized water. The bowl may be tapered in diameter along its length; and may be formed of a plastic material, which may be selected from at least one of a polymerized olefin, a fluoropolymer, and a plastic copolymer.

In another embodiment according to the invention, there is provided a filter container, comprising a top cap including a top cap mating member forming a first path around at least a portion of the top cap; and a bowl formed of a rigid material and including a bowl mating member forming a second path around at least a portion of the bowl. The top cap is sealed to the bowl such that, before opening of the seal of the top cap to the bowl, the top cap mating member is positioned above the seal of the top cap to the bowl, and the bowl mating member is positioned below the seal of the top cap to the bowl. The first path is capable of mating with the second path such that after opening of the seal of the top cap to the bowl, the top cap mating member may be mated with the bowl mating member to close the top cap to the bowl.

In a further embodiment according to the invention, there is provided a product container closure. The product container closure comprises an upper closure component including an upper flange that includes a first path around at least a portion of the upper flange; and a lower closure component including a lower flange that includes a second path around at least a portion of the lower flange. At least one of the first path and the second path includes a reduced thickness of material by comparison with surrounding material. The first path is at a different radial distance from a central axis of the product container closure than the second path around the extent of both the first path and the second path, such that exerting a force on an opening member creates a tear through the upper flange and lower flange, the tear forming between the first path and the second path and allowing opening of the product container closure.

In a further related embodiment, the product container closure further comprises an upper closure component mating member forming a third path around at least a portion of the upper closure component, and a lower closure component mating member forming a fourth path around at least a portion of the lower closure component. The upper closure component is sealed to the lower closure component such that, before opening of the seal of the upper closure component to the lower closure component, the upper closure component mating member is positioned above the seal of the upper closure component to the lower closure component, and the lower closure component mating member is positioned below the seal of the upper closure component to the lower closure component. The third path is capable of mating with the fourth path such that after opening of the seal of the upper closure component to the lower closure component, the upper closure component mating member may be mated with the lower closure component mating member to close the upper closure component to the lower closure component.

In related embodiments, the product container closure may be a closure for a filter cartridge container, the upper closure component being a top cap of the filter cartridge container, and the lower closure component being a bowl of the filter cartridge container. The first path, the second path, the third path and the fourth path may be substantially circular, the first path having a smaller diameter than the second path, and the third path having a smaller diameter than the fourth path.

In another embodiment according to the invention, there is provided a product container closure. The product container closure comprises an upper closure component mating member forming a first path around at least a portion of the upper closure component, and a lower closure component mating member forming a second path around at least a portion of the lower closure component. The upper closure component is sealed to the lower closure component such that, before opening of the seal of the upper closure component to the lower closure component, the upper closure component mating member is positioned above the seal of the upper closure component to the lower closure component, and the lower closure component mating member is positioned below the seal of the upper closure component to the lower closure component. The first path is capable of mating with the second path such that after opening of the seal of the upper closure component to the lower closure component, the upper closure component mating member may be mated with the lower closure component mating member to close the upper closure component to the lower closure component. The product container closure may be a closure for a filter cartridge container; the upper closure component may be a top cap of the filter cartridge container; and the lower closure component may be a bowl of the filter cartridge container.

In another embodiment according to the invention, there is provided a method for changing out a filter cartridge. The method comprises breaking a seal of a top cap of a filter container to a bowl of a filter container and opening the filter container. The top cap includes a top cap mating member forming a first path around at least a portion of the top cap, and the bowl is formed of a rigid material and includes a bowl mating member forming a second path around at least a portion of the bowl, wherein the top cap is sealed to the bowl such that, before opening of the seal, the top cap mating member is positioned above the seal of the top cap to the bowl and the bowl mating member is positioned below the seal of the top cap to the bowl. The method further comprises removing a fresh filter cartridge from the bowl, placing a spent filter cartridge into the bowl, and mating the top cap mating member with the bowl mating member to close the top cap to the bowl.

In a further embodiment according to the invention, there is provided a method of manufacturing a filter container. The method comprises placing a filter cartridge into a bowl of a filter container, the bowl being formed of a rigid material and including a bowl flange; and sealing a top cap flange of a top cap to the bowl flange. The top cap flange includes a first path around at least a portion of the top cap flange; and the bowl flange includes a second path around at least a portion of the bowl flange. At least one of the first path and the second path includes a reduced thickness of material by comparison with surrounding material. The first path is at a different radial distance from a central axis of the filter container than the second path around the extent of both the first path and the second path, such that exerting a force on an opening member is capable of creating a tear through the top cap flange and bowl flange, the tear being capable of forming between the first path and the second path and capable of opening the filter container. The method further comprises filling the filter container with liquid through an inlet tube in the top cap, while venting air through a vent tube in the top cap; sealing the inlet tube and vent tube when the filter container is filled with water and the filter cartridge is immersed within the bowl; and sterilizing the filter container under conditions sufficient to sterilize its contents.

In another embodiment according to the invention, there is provided a method of manufacturing a filter container. The method comprises placing a filter cartridge into a bowl of a filter container, the bowl being formed of a rigid material and including a bowl flange, and sealing a top cap flange of a top cap to the bowl flange. The top cap includes a top cap mating member forming a first path around at least a portion of the top cap, and the bowl includes a bowl mating member forming a second path around at least a portion of the bowl. The top cap is sealed to the bowl such that, before opening of the seal of the top cap to the bowl, the top cap mating member is positioned above the seal of the top cap to the bowl, and the bowl mating member is positioned below the seal of the top cap to the bowl. The first path is capable of mating with the second path such that if the seal of the top cap to the bowl is opened, the top cap mating member may be mated with the bowl mating member to close the top cap to the bowl. The method further comprises filling the filter container with liquid through an inlet tube in the top cap, while venting air through a vent tube in the top cap; sealing the inlet tube and vent tube when the filter container is filled with water and the filter cartridge is immersed within the bowl; and sterilizing the filter container under conditions sufficient to sterilize its contents.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an outside view of a filter container ready for shipment to an end user, according to an embodiment of the invention.

FIG. 2A is an isometric view of the filter container, according to an embodiment of the invention.

FIG. 2B is a detailed view of a pull tab and flange of the filter container, according to an embodiment of the invention.

FIG. 3 is a close-up view of the top portion of the filter container, according to an embodiment of the invention.

FIG. 4 is a close-up view of the connection of the filter container bowl to the filter container top cap, in accordance with an embodiment of the invention.

FIG. 5 is a detailed view of a pair of grooves in flanges of the filter container, in accordance with an embodiment of the invention.

FIG. 6 is an outside view of a filter container with a pull tab in the process of being removed, in accordance with an embodiment of the invention.

FIG. 7 is a cross section of the filter container with the flanges removed, in accordance with an embodiment of the invention.

FIG. 8 is a cross section of the filter container with the top cap closed to the bowl by a re-closure feature, in accordance with an embodiment of the invention.

FIG. 9 is a cross section of multiple empty filter container bowls stacked together for shipment or storage, in accordance with an embodiment of the invention.

FIG. 10 is a block diagram of a process for manufacturing a filter container according to an embodiment of the invention.

### DETAILED DESCRIPTION OF THE INVENTION

A description of example embodiments of the invention follows.

In accordance with an embodiment of the invention, there is provided a filter container using an integrated opening member and a re-closure feature, which provides a number of advantages in operator safety for installing, changing out, and disposing of filters by comparison with previous filter packaging techniques. The filter container removes the risk that the filter will de-wet before the filter is installed in a manufacturing process, and can be used to store the spent filter for safe transportation and disposal. Further features are discussed below.

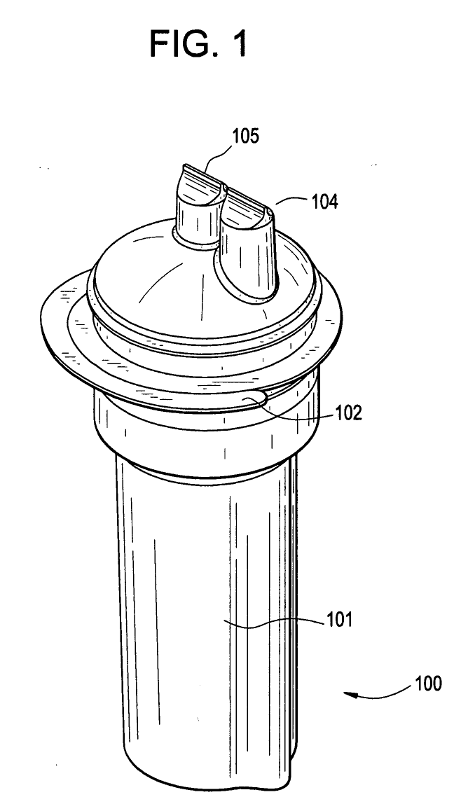

FIG. 1 is an outside view of a filter container 100 ready for shipment to an end user, according to an embodiment of the invention. A filter cartridge 101 is shipped immersed in a liquid, such as de-ionized water, contained within the container 100. A pull tab 102 or other opening member provides a convenient way of removing a filter cartridge 101 from the container 100 for installation in a manufacturing process. The filter cartridge 101 is removed from the filter container 100 by first pulling on the pull tab 102 to tear the pull tab off the container, as discussed further below. A pair of sealed-off tubes 104, 105 are on the filter container, having previously been used in sterilizing the filter cartridge 101 as discussed below. Subsequent figures show tubes 104, 105 prior to sealing.

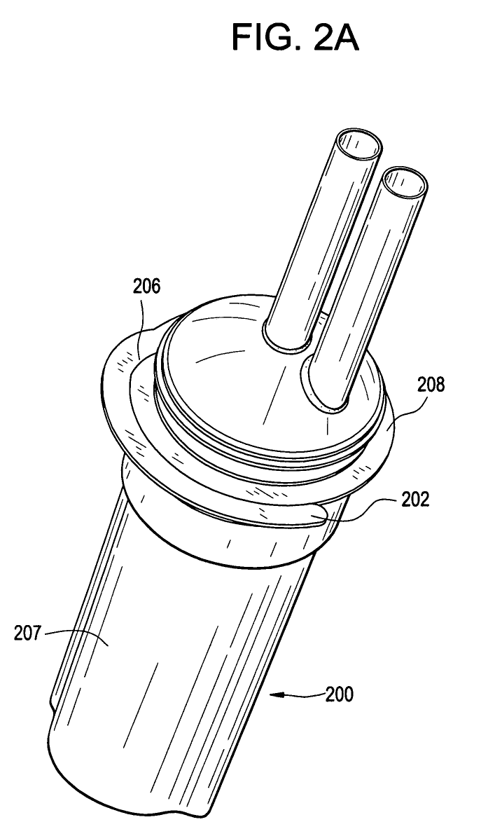

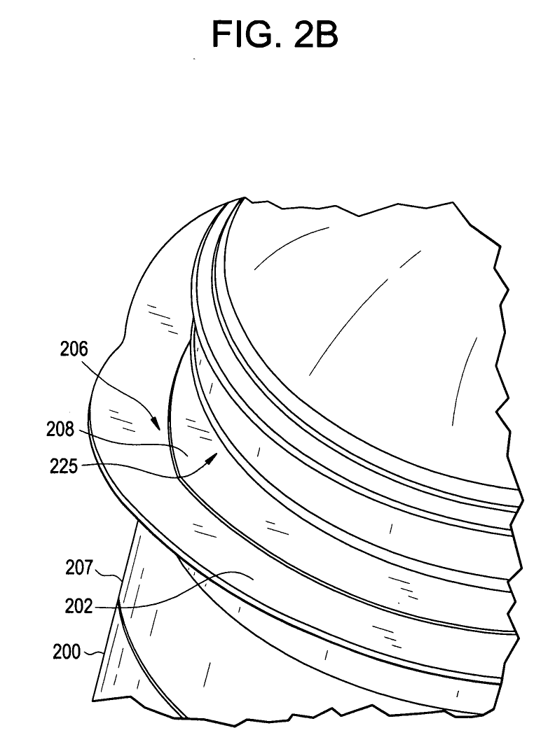

FIG. 2A is an isometric view of the filter container 200, according to an embodiment of the invention. An operator pulls on the pull tab 202, which begins to produce a tear along tear path 206, and continues to produce a tear in a path that closely follows the upper circumference of the filter container bowl 207 after an initial tear path visible at 206 in FIG. 2A. The pull tab 202 is formed as part of, or as an extension of, a removable flange 208.

FIG. 2B is a detailed view of the pull tab 202 and flange 208 of the filter container 200, according to an embodiment of the invention. It can be seen that after the initial tear path 206, the tear path closely follows the upper circumference of the filter container bowl 207, continuing around the circumference along path 225 such that the pull tab 202 and flange 208 may be torn off the container.

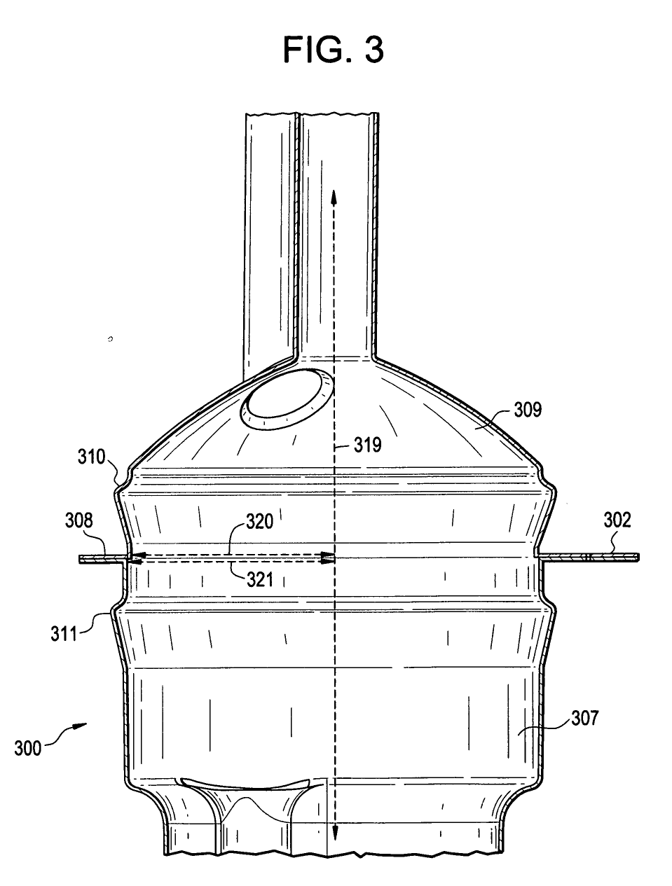

FIG. 3 is a close-up view of the top portion of the filter container 300, according to an embodiment of the invention. The filter container 300 includes a bowl 307 and a top cap 309, which is removed by tearing off the pull tab 302 and flange 308 to allow removal of the filter cartridge from the container 300. The top cap 309 is of a smaller diameter than the bowl 307, and is slightly tapered in diameter between a top cap mating member, such as wedge-shaped feature 310, and flange 308, with a narrower diameter at flange 308. Alternatively, the top cap 309 may be of a larger diameter than the bowl 307. A bowl mating member, such as wedge-shaped feature 311, is formed in the bowl 307.

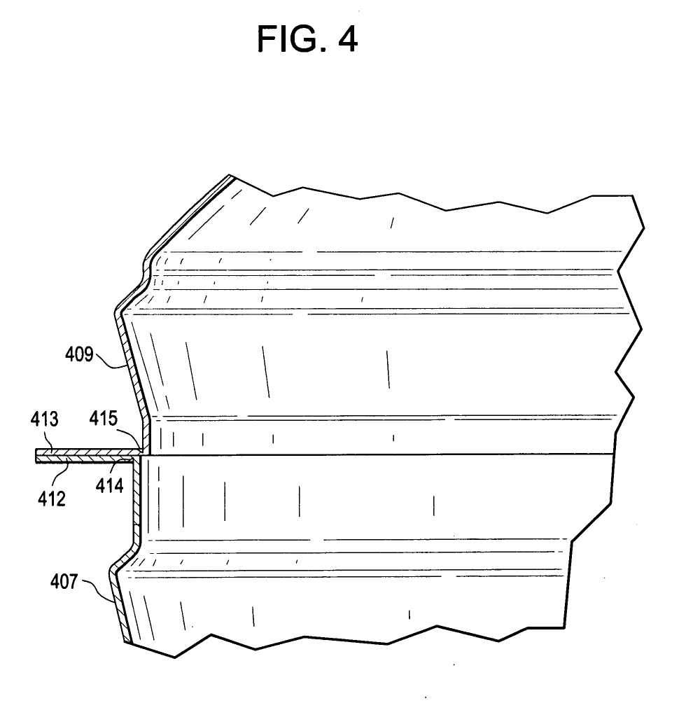

FIG. 4 is a close-up view of the connection of the filter container bowl 407 to the filter container top cap 409, in accordance with an embodiment of the invention. A flange 412 of the bowl 407 is bonded to a flange 413 of the top cap 409, which together form the flange 308 (see FIG. 3) and seal the filter container shut during storage and shipment. The pull tab 302 may be formed from an extension of either or both of the bowl flange 412 and top cap flange 413. In order to allow the pull tab and flange to be torn off, a lower groove 414 is formed in the flange 412 of the bowl 407, where the flange 412 meets the side of the bowl 407; and a corresponding upper groove 415 is formed in the flange 413 of the top cap 409, where the flange 413 meets the side of the top cap 409. Because the top cap 409 has a smaller diameter than the bowl 407, the upper groove 415 is positioned inside the lower groove 414, relative to the center of the filter container. Alternatively, where the top cap 409 has a larger diameter than the bowl 407, the upper groove 415 may be positioned outside the lower groove 414, relative to the center of the filter container.

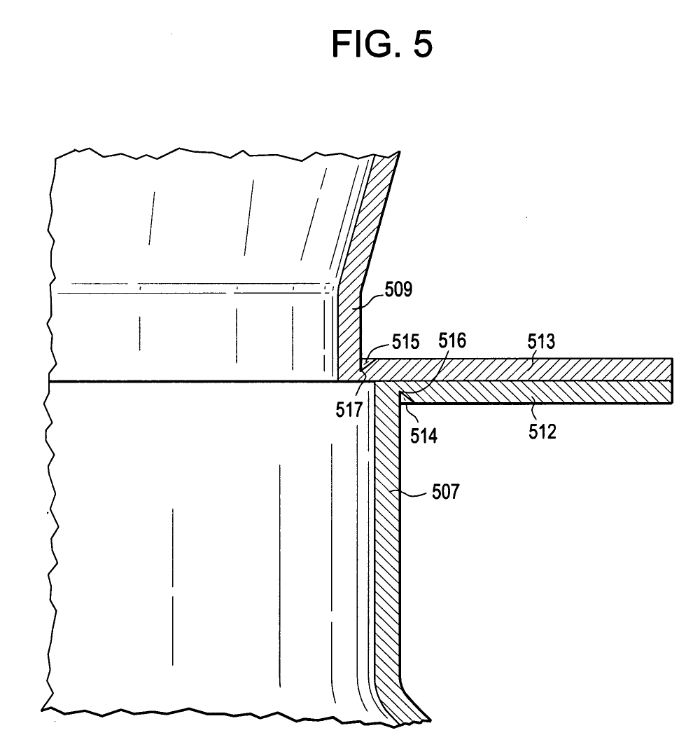

FIG. 5 is a detailed view of the grooves 514, 515 in the flanges 512, 513 of the filter container, in accordance with an embodiment of the invention. As the pull tab 102 is pulled to open the filter container, as shown in FIG. 1, a tear forms between the point 516 of the lower groove 514 and the point 517 of the upper groove 515, allowing the pull tab and flange to be torn away around the entire circumference of the bowl 507 and top cap 509, which removes the flanges 512, 513 and separates the top cap 509 from the bowl 507. It can be seen from the closer view of FIG. 5 that the bottom portion of the top cap 509 has a smaller diameter than the top portion of the bowl 507, so that the portion of the bowl 507 shown in FIG. 5 is outside, i.e., to the right in FIG. 5, of the portion of the top cap 509 in FIG. 5. Alternatively, the top cap 509 could have a larger diameter than the top portion of the bowl 507.

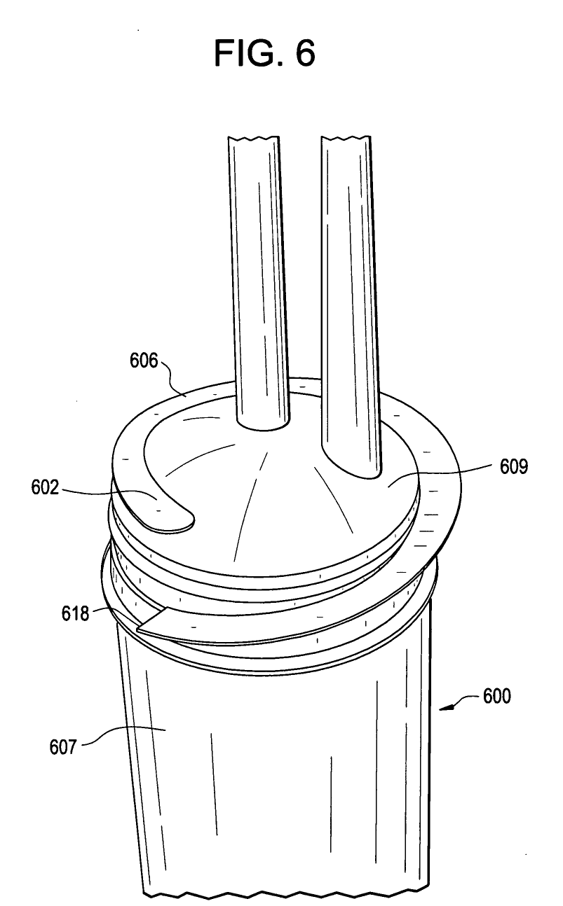

FIG. 6 is an outside view of the filter container 600 with the pull tab and flange in the process of being removed, in accordance with an embodiment of the invention. Once the tab 602 has been pulled, the tear path 606 removes the flange around the entire circumference of the top cap 609 and bowl 607. A weak attachment may be formed at 618 to attach the pull tab 602 at one point, which may be removed once the tear path 606 is fully torn. It should be appreciated that, as used herein, a “groove” may include either a notched path as shown in FIGS. 4 and 5, a perforation, or any other pattern used to at least partially reduce the thickness of the material along the path by comparison with surrounding material, thereby weakening the flange material along a tear path to allow the flange to be pulled away. Further, in an alternative embodiment, there need only be one groove, for example one groove on the bowl flange 512 (FIG. 5), or one groove on the top cap flange 513, rather than on both flanges, so long as the material thickness is sufficiently reduced by comparison with surrounding material to allow the flange to be pulled away. It will also be noted that FIG. 6 shows a slightly different top cap and mating member shape than in the other figures; this and other variations are possible in accordance with embodiments of the invention.

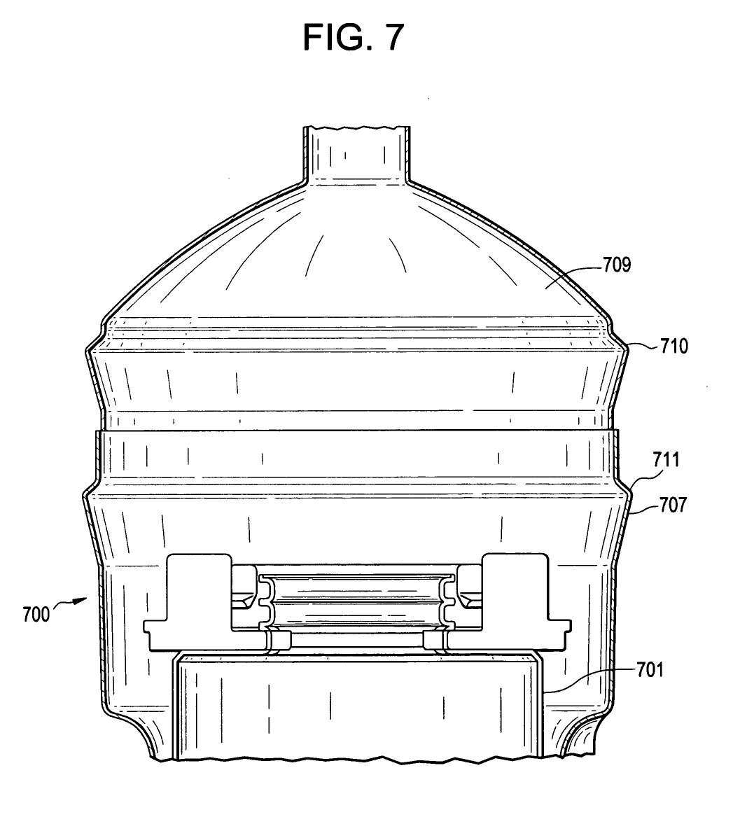

FIG. 7 is a cross section of the filter container 700 with the flanges removed, in accordance with an embodiment of the invention. Once the flanges have been torn off, as described for FIGS. 5 and 6, the top cap is removed and the fresh filter cartridge stored inside the container may be taken out of the container 700 and installed in a manufacturing process in which the filter cartridge is being used. Unlike conventional packages, there is no risk of the fresh filter cartridge dewetting before it is installed, because the filter may remain immersed in the filter container 700 until it is ready to be installed. A spent filter cartridge 701 that the fresh cartridge replaces may be removed from the manufacturing process, and conveniently stored inside the filter container 700, as shown in FIG. 7, for subsequent disposal. With the flange removed, once the spent cartridge 701 has been placed inside the container 700, the top cap 709 may be pushed down into the container 700 to engage a re-closure feature, thereby closing the spent cartridge within the container 700. This is possible because the bottom portion of the top cap 709 is of a different diameter than the top circumference of the bowl 707. FIG. 7 shows the top cap 709 as it is about to be pushed down into the filter container 700. When the top cap 709 is pushed down into the filter container 700, the wedge-shaped feature 710 of the top cap 709 engages with the wedge-shaped feature 711 of the bowl 707 to close the top cap 709 to the bowl 707. Although FIG. 7 shows the top cap 709 as having a smaller diameter than the bowl 707, it may instead have a larger diameter than the bowl 707, and be pushed down around the outside of the bowl 707 to close the top cap 709 to the bowl 707.

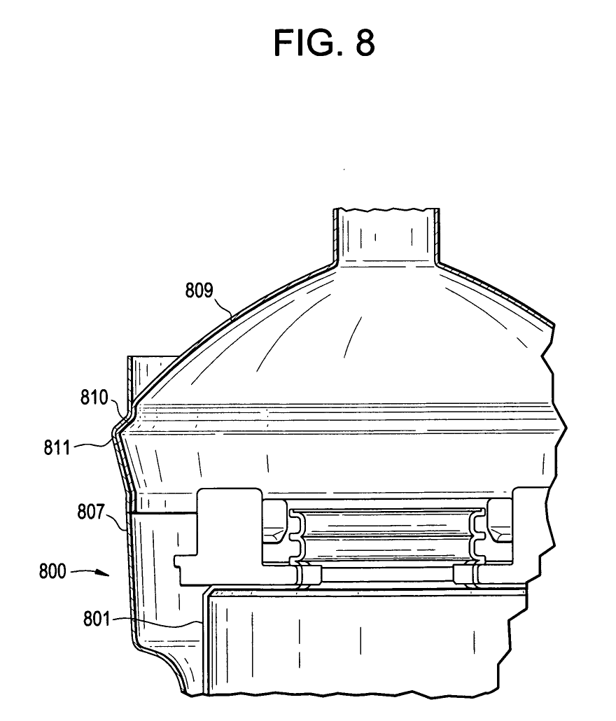

FIG. 8 is a cross section of the filter container 800 with the top cap 809 closed to the bowl 807 by the re-closure feature, in accordance with an embodiment of the invention. As can be seen, the spent cartridge 801 is now stored within the container 800, with the top cap 809 closed to the bowl 807 by the engagement of wedge-shaped feature 810 with wedge-shaped feature 811. The engagement of the wedge-shaped feature 810 with wedge-shaped feature 811 may form a hermetic seal, but need not, although the closure is preferably sufficient to prevent splashing and possibly spilling of the used chemicals in the filter bowl. Further, a top cap mating member and bowl mating member that are of a different type from wedge-shaped feature 810 and wedge-shaped feature 811 may be used instead. For instance, the top cap may feature a recessed mating member, and the bowl may feature a projecting rib mating member. The mating members may be of a semicircular or other cross-section rather than wedge-shaped. Other mating arrangements of the two parts are possible. Such a technique of storing the spent cartridge 801 provides safety advantages for end users of the filter cartridge, by comparison with conventional techniques, because the end user of a container according to an embodiment of the invention does not need to transport the spent cartridge by hand or place it on a flat surface, where the cartridge could leach chemicals and create a health hazard. Waste chemicals that are entrained in the filter cartridge are safely stored inside the filter container 800.

In an embodiment according to the invention, it will be appreciated that the upper groove 415 of FIGS. 4 and 5 forms a closed loop path around the top cap flange, such as a substantially circular path; and the lower groove 414 of FIGS. 4 and 5 forms a closed loop path around the bowl flange, such as a substantially circular path. As can be seen with reference to FIG. 3, the path through the top cap flange is parallel to the path through the bowl flange, but is radially closer to a central axis 319 of the filter container than the path through the bowl flange around the extent of both paths, as can be seen by the shorter radius 320 that extends between the central axis 319 and the path through the top flange, as compared with the slightly longer radius 321 that extends between the central axis 319 and the path through the bowl flange. Although FIG. 3 shows the path through the top cap flange as radially closer to the central axis than the path through the bowl flange, it may instead be further away from the central axis, for example if the top cap is of larger diameter than the bowl; and may generally be at a different radial distance from the central axis of the filter container than the path through the bowl flange. Further, there need only be one closed loop path, for example only through the bowl flange or only through the top cap flange, so long as the material is sufficiently weakened to create a tear. The mating member 310 of FIG. 3 forms a closed loop path around the top cap, and the mating member 311 of FIG. 3 forms a closed loop path around the bowl, both of which closed loop paths may be substantially circular. The path of the mating member 310 is capable of fitting within the path of the mating member 311 to close the top cap to the bowl; but may instead fit outside the path of the mating member 311, for example if the top cap is of larger diameter than the bowl. The closed loop paths need not necessarily be circular; other closed loop paths are possible, such as oval paths or other closed curves, for example if the filter container is oval in cross section, or some other shape. Further, it should be understood herein that although reference is made to closed loop paths, a similar path may be used that is not completely closed. For example, the upper and lower grooves 414 and 415 need not be perfectly closed paths, but could extend only part of the way around the top cap and bowl flanges, as long as they allow opening of the filter container; and the wedge-shaped feature 310 and wedge-shaped feature 311 could each extend around only a portion of the top cap and bowl, as long as they allowing closure of the top cap to the bowl. Further, a removable pull tab need not be used; a handle, loop, or any other opening member may also be used. For example, in one alternative embodiment, a loop-shaped handle may be used to create a tear through a pair of semicircular paths in the top cap flange and the bowl flange, with the paths not extending all the way around the top cap and bowl, but allowing opening of the filter container. In a still further alternative embodiment, a tear may be created through only one of the top cap flange and the bowl flange, as long as the closure of the top cap to the bowl may be opened. Such a feature of tearing through only one of the top cap flange and the bowl flange may be used in conjunction with a pair of mating members that allow re-closure of the filter container (for example as in the embodiment of FIG. 8).

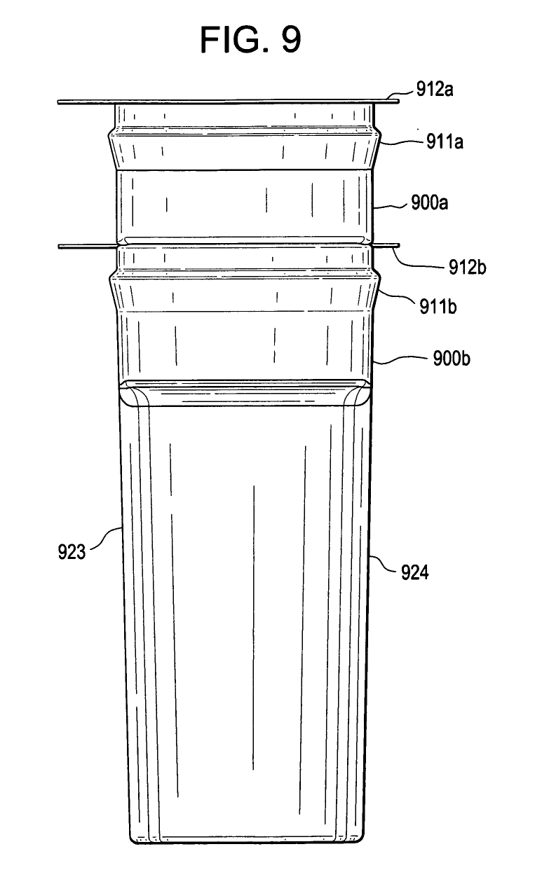

FIG. 9 is a cross section of multiple empty filter container bowls stacked together for shipment or storage, in accordance with an embodiment of the invention. A bowl of a first filter container 900a, which has flange 912a and wedge-shaped feature 911a, is placed inside a bowl of a second filter container 900b, which has flange 912b and wedge-shaped feature 911b. Because the body of the filter container bowls are tapered, they may be stacked inside each other before the top caps are sealed to them, which reduces the volume that the containers take up when they are empty. A pair of side ribs 923, 924 on the filter bowl 907b prevents the containers from air-locking together when stacked. Other similar features may also be used to prevent air-locking of the bowls.

A filter container according to an embodiment of the invention may be formed from a plastic material, for example a fluoropolymer such as PFA (perfluoro alkoxy polymer), MFA (modified fluoroalkoxy polymer) or PVDF (polyvinylidene difluoride), e.g., a material marketed under the name of Kynar® by Arkema Inc. of Philadelphia, Pa., U.S.A. Such materials allow good chemical compatibility, resistivity to acid, and temperature resistance. Such resistivity allows a used filter to be shipped for analysis, even though it is full of used chemicals such as strong acids, since the leaching of the acids does not damage the container. Other materials that may be used include polymerized olefins such as polypropylene and polyethylene; and copolymers of plastic materials, including copolymers of combinations of any of the foregoing fluoropolymers and polymerized olefins. For example, a copolymer of tetrafluoroethylene, PVDF, and/or other substances may be used.

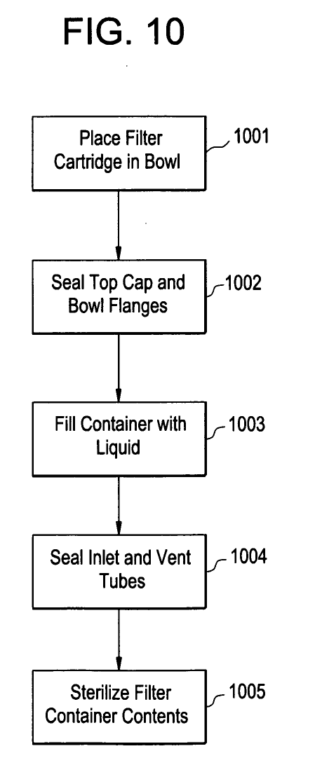

FIG. 10 is a block diagram of a process for manufacturing a filter container according to an embodiment of the invention. In step 1001, a filter cartridge is placed within the bowl of the filter container. In step 1002, the top cap is placed onto the bowl, and the flanges of the top cap and bowl (such as flanges 412, 413 of FIG. 4) are sealed together, for example by thermoplastic bonding, although other sealing techniques may be used, such as adhesives of various kinds, including natural, synthetic, drying, contact, reactive, light curing and pressure sensitive adhesives. In step 1003, the filter container is completely filled with a liquid solution, such as isopropyl alcohol or deionized water, which may enter through an inlet tube such as tube 104 of FIG. 1, while a vent tube such as tube 105 of FIG. 1 allows venting of air as the package is filled. Once the package is full of solution, the tubes 104 and 105 are sealed closed, for example by bonding with adhesives or ultrasonics, or by being pinched closed and heat sealed, in step 1004. In step 1005, the container is autoclaved under conditions sufficient to sterilize its contents. Because the container may be autoclaved, no bactericide need be contained in the solution, although a bactericide or other preservative may be used if desired. The package is less likely to burst during autoclaving than previous packages, because it is a rigid container and does not contain any air. Bactericides or preservatives may also be used with the filter container, without autoclaving.

An embodiment according to the invention provides a number of safety advantages over previous filter packages, including by allowing the spent filter cartridge to be stored safely without exposing the operator to hazardous fumes. In previous techniques, a spent filter was stored in a hazardous materials bag, which was then disposed of. Thus, an embodiment according to the invention saves on hazardous materials bags, and prevents the danger of puncture. It is also less hazardous and easier to handle than previous filter packages.

A filter container according to an embodiment of the invention may be used in any application where safety is desired, including for containing filter cartridges used in the semiconductor manufacturing and biomedical fields. Embodiments may also be used for products other than filter cartridges, where safety and purity are desired. Embodiments according to the invention provide the advantage of convenient handling and disposal for the end user, such as for hazardous chemical and biological substances.

In further embodiments according to the invention, a top cap similar to those described above may be used with a structure other than the filter bowls described herein. For example, a top cap similar to those described above may be fitted to a flange on a narrow rim similar to the top portion of the filter bowl described above, but with the narrow rim being attached to a bag or other container rather than to a filter bowl. Such a bag may be made of a plastic, such as a polymerized olefin or fluoropolymer, for example FEP (fluorinated ethylene-propylene). Other variations are possible.

While this invention has been particularly shown and described with references to example embodiments thereof, it will be understood by those skilled in the art that various changes in form and details may be made therein without departing from the scope of the invention encompassed by the appended claims.

What is claimed is:

1. A filter container, comprising:
a top cap; and
a bowl formed of a rigid material;
the top cap including a top cap flange that includes a first path around at least a portion of the top cap flange;
the bowl including a bowl flange that includes a second path around at least a portion of the bowl flange;
at least one of the first path and the second path including a reduced thickness of material by comparison with surrounding material;
the first path being at a different radial distance from a central axis of the filter container than the second path around the extent of both the first path and the second path, such that exerting a force on an opening member creates a tear through the top cap flange and bowl flange, the tear forming between the first path and the second path and allowing opening of the filter container.

2. A filter container according to claim 1, further comprising a top cap mating member forming a third path around at least a portion of the top cap, and a bowl mating member forming a fourth path around at least a portion of the bowl, the top cap being sealed to the bowl such that, before opening of the seal of the top cap to the bowl, the top cap mating member is positioned above the seal of the top cap to the bowl, and the bowl mating member is positioned below the seal of the top cap to the bowl;
the third path being capable of mating with the fourth path such that after opening of the seal of the top cap to the bowl, the top cap mating member may be mated with the bowl mating member to close the top cap to the bowl.

3. A filter container according to claim 2 wherein the first path, the second path, the third path and the fourth path are substantially circular, the first path having a smaller diameter than the second path, and the third path having a smaller diameter than the fourth path.

4. A filter container according to claim 1, the top cap further including an inlet tube and a vent tube.

5. A filter container according to claim 3, further including a filter cartridge within the container, the filter cartridge being immersed in a liquid.

6. A filter container according to claim 5, the liquid being deionized water.

7. A filter container according to claim 2, the bowl being tapered in diameter along its length.

8. A filter container according to claim 2, the bowl being formed of a plastic material.

9. A filter container according to claim 8, wherein the material is selected from at least one of a polymerized olefin, a fluoropolymer, and a plastic copolymer.

10. A filter container, comprising:
a top cap including a top cap mating member forming a first path around at least a portion of the top cap; and
a bowl formed of a rigid material and including a bowl mating member forming a second path around at least a portion of the bowl;
the top cap being sealed to the bowl such that, before opening of the seal of the top cap to the bowl, the top cap mating member is positioned above the seal of the top cap to the bowl, and the bowl mating member is positioned below the seal of the top cap to the bowl;
the first path being capable of mating with the second path such that after opening of the seal of the top cap to the bowl, the top cap mating member may be mated with the bowl mating member to close the top cap to the bowl.

11. A filter container according to claim 10 wherein the first path and the second path are substantially circular, the first path having a smaller diameter than the second path.

12. A filter container according to claim 10, the top cap further including an inlet tube and a vent tube.

13. A filter container according to claim 12, further including a filter cartridge within the container, the filter cartridge being immersed in a liquid.

14. A filter container according to claim 13, the liquid being deionized water.

15. A filter container according to claim 10, the bowl being tapered in diameter along its length.

16. A filter container according to claim 10, the bowl being formed of a plastic material.

17. A filter container according to claim 16, wherein the material is selected from at least one of a polymerized olefin, a fluoropolymer, and a plastic copolymer.

18. A product container closure, comprising:
an upper closure component including an upper flange that includes a first path around at least a portion of the upper flange;
a lower closure component including a second path around at least a portion of the lower flange;
at least one of the first path and the second path including a reduced thickness of material by comparison with surrounding material;
the first path being at a different radial distance from a central axis of the product container closure than the second path around the extent of both the first path and the second path, such that exerting a force on an opening member creates a tear through the upper flange and lower flange, the tear forming between the first path and the second path and allowing opening of the product container closure.

19. A product container closure according to claim 18, further comprising an upper closure component mating member forming a third path around at least a portion of the upper closure component, and a lower closure component mating member forming a fourth path around at least a portion of the lower closure component, the upper closure component being sealed to the lower closure component such that, before opening of the seal of the upper closure component to the lower closure component, the upper closure component mating member is positioned above the seal of the upper closure component to the lower closure component, and the lower closure component mating member is positioned below the seal of the upper closure component to the lower closure component;
the third path being capable of mating with the fourth path such that after opening of the seal of the upper closure component to the lower closure component, the upper closure component mating member may be mated with the lower closure component mating member to close the upper closure component to the lower closure component.

20. A product container closure according to claim 19, the product container closure being a closure for a filter cartridge container, the upper closure component being a top cap of the filter cartridge container, and the lower closure component being a bowl of the filter cartridge container.

21. A product container closure according to claim 20, wherein the first path, the second path, the third path and the fourth path are substantially circular, the first path having a smaller diameter than the second path, and the third path having a smaller diameter than the fourth path.

22. A product container closure, comprising:
an upper closure component mating member forming a first path around at least a portion of the upper closure component, and a lower closure component mating member forming a second path around at least a portion of the lower closure component, the upper closure component being sealed to the lower closure component such that, before opening of the seal of the upper closure component to the lower closure component, the upper closure component mating member is positioned above the seal of the upper closure component to the lower closure component, and the lower closure component mating member is positioned below the seal of the upper closure component to the lower closure component;
the first path being capable of mating with the second path such that after opening of the seal of the upper closure component to the lower closure component, the upper closure component mating member may be mated with the lower closure component mating member to close the upper closure component to the lower closure component.

23. A product container closure according to claim 22, the product container closure being a closure for a filter cartridge container, the upper closure component being a top cap of the filter cartridge container, and the lower closure component being a bowl of the filter cartridge container.

24. A method for changing out a filter cartridge, comprising:
breaking a seal of a top cap of a filter container to a bowl of a filter container and opening the filter container, the top cap including a top cap mating member forming a first path around at least a portion of the top cap, and the bowl being formed of a rigid material and including a bowl mating member forming a second path around at least a portion of the bowl, wherein the top cap is sealed to the bowl such that, before opening of the seal, the top cap mating member is positioned above the seal of the top cap to the bowl and the bowl mating member is positioned below the seal of the top cap to the bowl;
removing a fresh filter cartridge from the bowl;
placing a spent filter cartridge into the bowl; and
mating the top cap mating member with the bowl mating member to close the top cap to the bowl.

25. A method according to claim 24, wherein the first path and the second path are substantially circular, the first path having a smaller diameter than the second path.

26. A method according to claim 24, wherein the fresh filter cartridge is immersed in deionized water within the filter container.

27. A method according to claim 24, wherein the bowl is formed of a plastic material.

28. A method according to claim 27, wherein the material is selected from at least one of a polymerized olefin, a fluoropolymer, and a plastic copolymer.

29. A method of manufacturing a filter container, comprising:
placing a filter cartridge into a bowl of a filter container, the bowl being formed of a rigid material and including a bowl flange;
sealing a top cap flange of a top cap to the bowl flange, the top cap flange including a first path around at least a portion of the top cap flange, and the bowl flange including a second path around at least a portion of the bowl flange, at least one of the first path and the second path including a reduced thickness of material by comparison with surrounding material, the first path being at a different radial distance from a central axis of the filter container than the second path around the extent of both the first path and the second path, such that exerting a force on an opening member is capable of creating a tear through the top cap flange and bowl flange, the tear being capable of forming between the first path and the second path and capable of opening the filter container;
filling the filter container with liquid through an inlet tube in the top cap, while venting air through a vent tube in the top cap;
sealing the inlet tube and vent tube when the filter container is filled with water and the filter cartridge is immersed within the bowl; and
sterilizing the filter container under conditions sufficient to sterilize its contents.

30. A method according to claim 29, wherein the top cap includes a top cap mating member forming a third path around at least a portion of the top cap, and the bowl includes a bowl mating member forming a fourth path around at least a portion of the bowl, the top cap being sealed to the bowl such that, before opening of the seal of the top cap to the bowl, the top cap mating member is positioned above the seal of the top cap to the bowl, and the bowl mating member is positioned below the seal of the top cap to the bowl;
and wherein the third path is capable of mating with the fourth path such that if the seal of the top cap to the bowl is opened, the top cap mating member may be mated with the bowl mating member to close the top cap to the bowl.

31. A method of manufacturing a filter container, comprising:
placing a filter cartridge into a bowl of a filter container, the bowl being formed of a rigid material and including a bowl flange;
sealing a top cap flange of a top cap to the bowl flange, wherein the top cap includes a top cap mating member forming a first path around at least a portion of the top cap, and the bowl includes a bowl mating member forming a second path around at least a portion of the bowl, the top cap being sealed to the bowl such that, before opening of the seal of the top cap to the bowl, the top cap mating member is positioned above the seal of the top cap to the bowl, and the bowl mating member is positioned below the seal of the top cap to the bowl, and wherein the first path is capable of mating with the second path such that if the seal of the top cap to the bowl is opened, the top cap mating member may be mated with the bowl mating member to close the top cap to the bowl;
filling the filter container with liquid through an inlet tube in the top cap, while venting air through a vent tube in the top cap;
sealing the inlet tube and vent tube when the filter container is filled with water and the filter cartridge is immersed within the bowl; and
sterilizing the filter container under conditions sufficient to sterilize its contents.
